(19) United States
(12) Patent Application Publication
(10) Pub. No.: US 2008/0276466 A1
(43) Pub. Date: Nov. 13, 2008

(54) Ambidextrous spill-resistant spoon

(76) Inventor: Phillip Currie, BuenaPark, CA (US)

Correspondence Address: Terry L. Miller, 24832 Via San Fernando, Mission Viejo, CA, 92692, US

(21) Appl. No.: 12/218,888

(22) Filed: Jul. 18, 2008

Related U.S. Application Data
(63) Continuation-in-part of application No. 11/246,661, filed on Oct. 7, 2005, now Pat. No. 7,416,377.
Application No. 11/246,661 is a division of application No. 10/848,671, filed on May 19, 2004, now Pat. No. 7,178,247.

(51) Int. Cl. A47J 43/28; F16D 11/04

(52) U.S. Cl. 30/327; 30/324; 192/66.1

(57) ABSTRACT

An ambidextrous spill-resistant spoon includes a handle portion carrying a spoon bowl portion. The spoon bowl is rotational relative to the handle portion and depends below the handle portion to self-level rather as a pendulum seeks the vertical. But, the spoon bowl is clutched non-rotationally to the handle portion during a scooping motion to load the spoon with food. As soon as the scooping motion is completed by clearing of the spoon bowl from the food, the bowl portion is unclutched from the handle portion and becomes freely pivotal so as to remain level as a user moves the loaded spoon toward the user's mouth.

### CROSS REFERENCE TO RELATED APPLICATIONS

This application is a Continuation-in-Part of allowed U.S. application Ser. No. 11/246,661, filed 7 Oct. 2005, now U.S. Pat. No. ______, granted ______, which is a Divisional application of U.S. application Ser. No. 10/848,671, filed 19 May 2004, now U.S. Pat. No. 7,178,247, granted 20 Feb. 2007.

### FIELD OF THE INVENTION

The present invention relates to improvements in a spoon having a handle portion and a spoon bowl portion connected by a rotational mechanism and a selectively operable clutching mechanism. The rotational mechanism allows the spoon bowl to swing freely like a pendulum below and relative to an axis passing longitudinally along the handle portion. The selectively operable clutching mechanism engages the handle portion and the bowl portion in response to axial force and torque resulting from a user scooping up food. When the user lifts the food on the spoon, the clutching mechanism is responsive torque and the gravitational vector to unclutch and allow the bowl portion to swing freely relative to the handle portion. As a result, those who have undeveloped or impaired coordination enjoy greater success in using the spoon to feed themselves.

### BACKGROUND OF THE INVENTION

A variety of improved spoons have been made in order to facilitate use by individuals with undeveloped or impaired coordination (i.e., infants or stroke victims, for example). These spoons are intended to allow infants, the elderly, and the disabled to participate more fully in feeding themselves.

Improvements in conventional spoons of this character sometimes relate to weighting or texturing or configuring the handle (See, for example, U.S. Pat. No. 4,389,777), such that the handle is more easily grasp or manipulated. This expedient does not address the undeveloped or impaired coordination that may prevent the user from being able to accomplish leveling of the spoon bowl so that food does not fall off the side of the spoon. The user may not even be aware of the need for or their inability to accomplish leveling of the spoon bowl.

Other improved conventional spoons simply allow the bowl portion to swing freely like a pendulum relative to the handle (See, U.S. Pat. No. 6,393,704), and it is known to add additional weighting to the bowl portion or to a shaft carrying the bowl portion to increase the pendulum action (i.e., self leveling action) of the spoon bowl. This conventional expedient makes such a spoon a very difficult utensil when it is desired to scoop up food onto the spoon. Even a person with perfectly normal coordination in attempting to use such a spoon will find that the utensil is frustrating and requires a special concentration and coordination in order to scoop up food into the freely swinging spoon bowl. Such a utensil is very frustrating for those with undeveloped or impaired coordination.

Other conventional improved spoons add various versions and arrangements of clutches to momentarily engage (rotationally lock for movement in unison) the spoon bowl to the handle to improve the action of the spoon in scooping up food (See, for example, U.S. Pat. Nos. 2,636,266; 2,741,027; 4,028,803; 4,993,156; and 5,630,276). Some of these clutches or locking mechanisms are to be manually operated, which may be beyond the understanding of an infant, or beyond the physical ability of the impaired. Other clutch mechanisms are intended to engage and disengage in response to the forces, angulations, and rotations of a spoon in use. U.S. Pat. No. 2,636,266 is an example of this intention. However, consideration of FIG. 2 of the '266 patent will show that the spoon must be pushed into the food in an unnatural way in order to get that particular clutch mechanism to engage. If the spoon is used in a natural scooping motion, the clutch will disengage at the time when the user would want it to be engaged. Once the bowl of the spoon is loaded with food, the clutch of the '266 patent would appear to unclutch as desired, as is seen in FIG. 5 of this patent. Consideration of the operation of the '266 patent makes clear that any clutching mechanism must not only disengage when desired once the spoon bowl is loaded with food, but must also engage in response to the most natural scooping motions that a user will make in attempting to use the spoon.

Another spoon including a clutch mechanism attempts to use a spring-loaded mechanism in order to effect clutching and unclutching of the spoon bowl and handle (See, for example, U.S. Pat. No. 2,741,027). However, these mechanisms are subject to sticking and fouling either on their own or as a result of food entering the mechanism. Some spoons of this character require angulation or tipping of the handle portion to effect clutching and unclutching (See my own U.S. Pat. No. 4,028,803, for example). Still other spoons of this character add manual clutch operating features (such as a clutch operated by a thumb pad) or have exterior protrusions, levers, or bob weights, all of which are not desirable for use by an infant or the impaired.

### SUMMARY OF THE INVENTION

In view of the above, an object for this invention is to reduce or eliminate the effect of one or more of the deficiencies of the conventional art.

In accordance with the principles of the present invention, an ambidextrous spill-resistant spoon includes an elongate handle portion defining a longitudinal axis. The spoon includes a spoon bowl portion having a shaft part, and a rotational and clutching apparatus connecting the handle portion and the spoon bowl via the shaft part so that the spoon bowl is relatively rotationally supported below the longitudinal axis, the rotational and clutching apparatus further being responsive to a certain user input including an axial force pushing the handle portion and spoon bowl toward one another to clutch the spoon bowl non-rotationally to the handle portion to resist torque in both directions in the presence of the axial force, and the rotational and clutching apparatus being responsive to torque in the absence of the axial force to unclutch allowing the spoon bowl to freely rotate about the longitudinal axis. Because the spoon bowl is clutched to the handle portion in opposition to torque in both directions, the spoon is ambidextrous, and can be used both left-handed and right-handed.

These and other features and advantages of the present invention will be readily apparent from a thoughtful consideration of the following detailed description of one exemplary embodiment of the invention. This detailed description will be better understood in conjunction with the accompanying drawings, wherein like reference characters represent like elements, as follows:

### BRIEF DESCRIPTION OF THE DRAWING FIGURES

FIG. 1 is a fragmentary perspective view partially in cross section of an exemplary spoon according to this invention being used to scoop up food as from a bowl;

FIG. 2 is a side elevation view of the ambidextrous spill-resistant spoon seen in FIG. 1;

FIG. 3 is an exploded side elevation view, partially in cross section, and at an enlarged size compared to FIGS. 1 and 2, of an ambidextrous spill-resistant spoon according to this invention;

FIG. 4 is a side elevation assembly view, at a still more greatly enlarged size in comparison to that of FIG. 3, and partially in cross section, showing the rotational and clutching mechanisms of the inventive spoon;

FIG. 5 is view combining a side view and an axial view of portions of the spoon seen in FIG. 4, and at a still more greatly enlarged size compared to FIG. 4, so as to show details of the rotational and clutching mechanism according to this invention, and with the element in the left-hand side of this Figure rotated 90° to face the viewer in axial view so as to better illustrate details of the structure.

### DETAILED DESCRIPTION OF AN EXEMPLARY

### Preferred Embodiment of the Invention

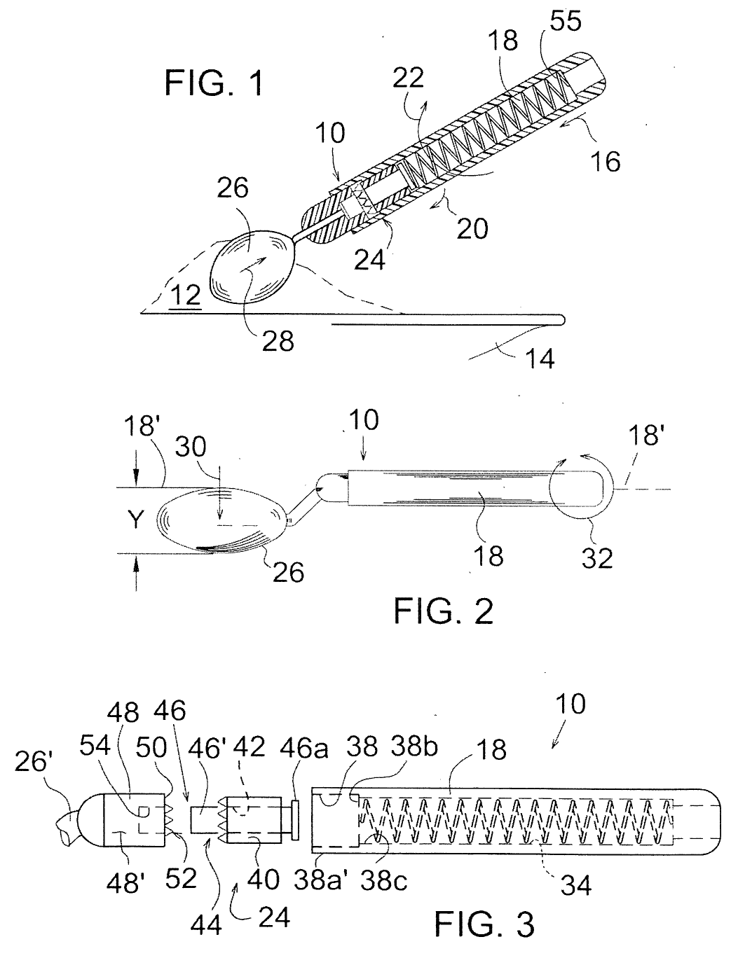

An ambidextrous spill-resistant spoon 10 according to the present invention is illustrated in FIG. 1. The ambidextrous spill-resistant spoon is shown in FIG. 1 as it would appear when held in the right hand of a user (not seen in the drawing Figures) while being used to scoop up food 12 from a bowl 14. The viewer of FIG. 1 is presented generally in the position of (and has the general point of view of) the user of the spoon 10. As illustrated, the user is scooping up food by inserting the spoon bowl into the food, and drawing the spoon and food toward the user using the right hand.

As is seen in FIG. 1, the natural scooping motion for a spoon held in the right hand is downwardly and into the food (illustrated by axial arrow 16 along the axis of a handle portion 18 of the spoon 10) with the user then drawing the spoon 10 toward the user (illustrated by arcuate arrow 20—this arrow being directed generally out of FIG. 1 toward the viewer of this Figure) and possibly in combination with a rotation of the handle portion 18 in a clockwise direction (indicated by rotational arrow 22). This relative rotation indicated by arrow 22 results most naturally from articulation of the users wrist, elbow, and shoulder as the right hand holds the spoon 10 while this spoon is drawn into and through the food 12 toward the user. As these motions are conducted by the user of the spoon 10 a rotational and clutching mechanism (generally indicated with arrowed numeral 24) within the handle 18 of spoon 10 and which is responsive to these motions and resulting forces clutches the bowl portion 26 to the handle 18 in order to allow torque to be applied in the direction indicated by arrow 22.

Of course, it is understood that these motions are not distinct and discreet, but occur in combination with one another essentially as a single scooping motion by the user of the spoon 10. FIG. 1 also shows that as a reaction to the downward motion 16 of the spoon 10 into the food 12, the bowl portion 26 of the spoon experiences an axially directed reaction force, indicated by arrow 28. It will be seen that a very early and initial result of this reaction force 28 is a slight axial relative movement of the bowl 26 toward handle portion 18 and the engagement of rotational and clutching mechanism 24 in order to sustain clockwise torque 22. That is, the bowl 26 is temporarily locked non-rotationally to the handle portion 18.

That is, during the scooping motion indicated in FIG. 1, it is desirable to have the handle portion 18 clutch to the bowl portion 26 so that the user may more effectively scoop up food 12 onto this bowl portion 26 of the spoon. However, as is seen in FIG. 2, once the user has loaded the bowl portion 26 of the spoon 10 with food (indicated by the weight arrow 30) and lifted the spoon 10 free of the food 12, then it is desirable to have the handle portion 18 and bowl portion 26 be freely rotational relative to one another, as is indicated by bi-directional arrow 32. It follows that the spoon bowl 26 is now also freely rotational relative to the handle portion 18. The bi-directional arrow 32 indicates that the handle portion 18 is freely rotational in both directions about an axis 18′ relative to the bowl portion 26. Accordingly, as a result of an offset (indicated by vertical distance Y) of the bowl portion 26 below the axis 18′ of handle 18, the weight of the bowl portion 26 in combination with the food held in this bowl portion (recalling weight arrow 28) causes the bowl portion 26 to swing or rotate freely like a pendulum about axis 18′ as the user moves the spoon toward the users mouth. Thus, even though the user may have undeveloped or impaired fine motor coordination of the fingers and wrist, the motions of the user's elbow and shoulder in moving the spoon to the user's mouth will be sufficient. And, rotational motion of bowl portion 26 relative to handle portion 18 will result in the bowl 26 remaining substantially level, and thus will essentially prevent food from spilling off the spoon 10.

In order to achieve the necessary automatic clutching and unclutching of the bowl portion 26 and handle portion 18 (recalling FIGS. 1 and 2), in conjunction with the free rotational relationship desired during movement of the loaded spoon 10 to a user's mouth (recalling arrow 32 of FIG. 2), the present invention uses a rotational and clutching mechanism or assembly 24 having the following attributes in combination:
clutching of bowl 26 and handle 18 together in response to an axial force and very slight axial motion of the bowl portion 26 toward handle portion 18 at the beginning of the scooping motion which places food on the spoon;
maintenance of clutching in opposition to applied torque during the scooping motion (recalling arrow 22 of FIG. 1);
immediate un-clutching (i.e., bowl 26 freely rotational relative to handle 18) when the scooping motion is completed (i.e., by clearing of the spoon from the food 12) in response to cessation of the prevailing axial force and scooping torque applied by the user on the spoon handle, and in response to a possible combination of a gravitational vector along with an opposite torque (i.e., opposite to the scooping torque) which results from the weight of the spoon bowl and food thereon acting through a lever arm “y”; followed by;
free rotational motion (i.e., leveling) of the bowl 26 relative to handle 18 during transport of the loaded spoon to the user's mouth (recalling arrow 32 of FIG. 2).

Considering FIGS. 3-5 in combination, it is seen that the present invention achieves these objectives and actions by use of a structure that is robust, exceedingly simple mechanically with a minimum of parts, and which also achieves a unique structure utilizing a combination of physical effects to achieve its operation. Turning first to FIG. 3, it is seen that the handle 18 is formed of a tubular body preferably having a stepped through bore or passage 34.

At a distal end of the handle 18 (i.e., the left end of this handle for a viewer of FIG. 3), the handle portion 18 defines a counter bore 38 having a first cylindrical section 38a, an axial shoulder 38b, and another or inner cylindrical section 38c. The section 38c may, if desired, extend substantially the full length of the spoon handle 18 to define most of the passage 34. Adjacent to the right end of the passage 34, the cylindrical section 38c optionally defines a step or shoulder 36, functioning as a spring seat for an optional spring, as will be further explained.

The handle 18 defines a collar section 38a′ at counter bore 38a, which collar section acts somewhat as a shield in cooperation with a carrier member to be described below. That is, the collar section 38a′ assists in preventing or minimizing the entry of food into the spoon 10.

The features of counter bore 38 forms part of the rotational and clutching assembly 24, with the remainder of this mechanism being fitted into the counter bore 38. The mechanism 24 includes a bushing member 40 which at its outer diameter surface may define a removable press fit into the counter bore section 38c. Alternatively, the bushing member 40 may be a permanent press fit into the counter bore section 38c, or may be permanently secured, as by adhesive bonding or ultrasonic welding, for example, into this bore. Importantly, the bushing member 40 is non-rotational relative to handle portion 28.

Bushing member 40 defines a through bore 42. At its distal axial end surface, the busing member 40 defines a circular array of fine-dimension, axially-extending engagement teeth, generally indicated with the arrowed numeral 44 in FIG. 3. Preferably, as is seen best in FIG. 5, these engagement teeth are wedge-shaped, and are substantially symmetrically circumferentially, so that they prevent relative rotation when engaged, and produce an equal axial disengaging force in response to torque in either direction. Rotationally received through bore 42 is a headed shaft member 46. That is, the shaft member 46 includes a head portion 46a and a distally extending cylindrical portion 46′. Non-rotationally received permanently on the distal portion 46′ of shaft member 46 is a carrier member 48. This carrier member 48 carries the shaft 26′ of spoon bowl 26. Also, this carrier member 48 defines a cylindrical section 48′ which is received into section 38a of counter bore 38 with a radial clearance somewhat greater than the radial clearance between shaft member 46 and bore 42 of bushing member 40. Thus, the carrier member 48 at surface 48′ is closely spaced from and freely rotational within the collar 38′, and these elements cooperatively form a shield resisting entry of food particles into the mechanism 24. That is, integral parts of the handle 18 and of carrier member 48 serve as a self-formed shield structure to resist entry of food particles into the rotational and clutching mechanism.

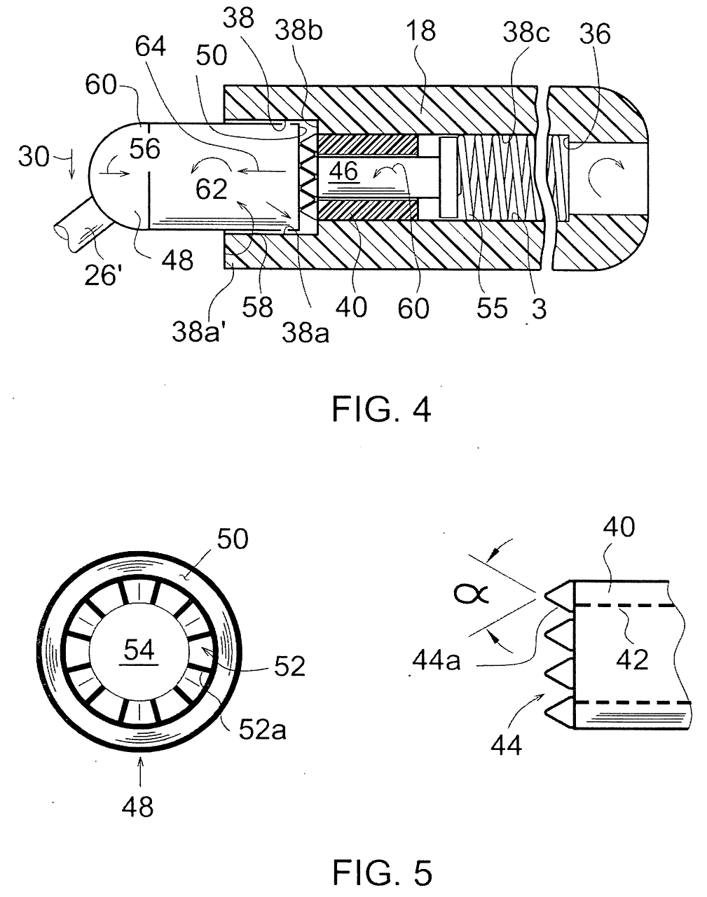

Carrier member 48 also defines a shoulder 50 confronting the step 38b on bore 34 at counter bore 38. Also, at its proximal axial end surface, the carrier member 48 defines a circular array of fine-dimension axial ratchet teeth, generally indicated with the arrowed numeral 52 in FIG. 3. The ratchet teeth 44 and 52 are matching in configuration, with an included angle as indicated at a on FIG. 5, defined between wedge-like axially and circumferentially extending surfaces 44a and 52a. When the teeth 44 and 52 are engaged with one another, they sustain torque applied at handle 18 and reacted at spoon bowl 26, as is best seen in FIGS. 4 and 5. Within the array of ratchet teeth 52, the carrier member 48 defines a blind bore 54 permanently receiving the end portion 46′ of shaft member 46. That is, the end portion 46′ may be permanently secured into bore 54 by use of an epoxy adhesive or ultrasonic welding, for example.

Considering now the details revealed in FIGS. 4 and 5, it is seen that the ratchet teeth 44 and 52 are of fine dimension. That is, these ratchet teeth are preferably only about 0.015 inch deep. Thus, an axial motion of just slightly more than 0.015 between the bushing member 40 and carrier member 48 is sufficient to fully engage or disengage the ratchet teeth 44 and 52 with or from one another. Further, the ratchet teeth 44 and 52 have a sufficiently shallow included ramp angle (angle α on FIG. 5) so that a very slight axial force will engage these teeth, and yet the engaged teeth will then sustain an applied torque between the handle 18 and bowl 26 of the spoon 10. So, viewing FIG. 5 it is seen that the ratchet teeth 44, 52 each have an engagement surface 44a, 52a, and when these engaged teeth are subject to an applied torque in the absence of an axial force, they tend to wedge out of engagement, and allow the spoon bowl to pivot on shaft 46 freely relative to handle portion 18. An optional spring 55 may be provided within the bore 34 and extending between the head 46a and spring seat 36 to assist in the action of the spoon 10, as is explained below.

Further, now viewing FIG. 4, it is to be understood that the sequence of events during scooping of food with the spoon 10 first results in a slight axial motion 56 (recalling axial forces 16 and 28 illustrated on FIG. 1, as the spoon is pushed into the food 12 (or along the bottom of the plate or bowl containing the food 12). This slight axial motion 56 is sufficient to both engage the ratchet teeth 44 and 52 with one another (as seen in FIG. 4). Because the ratchet teeth 44 and 52 are engaged, the torque 22 is sustained, and the spoon 10 is effective to scoop up food. However, as soon as the spoon bowl 26 clears the food 12, a combination of factors is effective to declutch the mechanism 24 (i.e., to disengage the ratchet teeth 44 and 52) and to make the spoon bowl 26 freely pivotal like a pendulum below axis 18′. That is, the weigh of the spoon bowl 26 and the weight 30 of food therein is effective to produce a torque 58 acting on the wedge surfaces 44a and 52a of the teeth 44, 52 to move the carrier 50 axially, and to disengage the teeth 44, 52. For this purpose, the spring 55 may be also provided within bore 34, in order to assist in unclutching the mechanism 24. By selection of the included angle 44a, 52a of the teeth 44 and 52, and the spring rate and preload of the spring 55 (is utilized), positive engaging and disengaging of the clutch mechanism 24 may be achieved.

The forces acting on the carrier 48 are a torque from the weight of the spoon bowl 26 and food 30, possibly a gravitational vector because the spoon may be canted downwardly, and an axial force resulting from the wedging apart of teeth 44 and 52 in combination with the axial force from spring 55 (if utilized). This combination of forces is sufficient to unclutch the teeth 44 and 52, and allow the spoon bowl 26 to self-level, somewhat like a pendulum below the pivot axis 18′. The result is an almost immediate and imperceptible transition of the spoon bowl 26 from a clutched condition to an unclothed and freely pivotal condition, in which the spoon bowl is self-leveling to better retain food thereon. Even though the weight of the spoon bowl 26 itself and the weight 30 of food thereon is not great, the unclutching action accomplished by the present invention is positive and reliable. Importantly, the torque effect and vector effect together (along with spring 55, if utilized) are very effective to overcome static friction and to (once motion begins) convert the frictional relationship of shaft 46 with bushing 40 to one of dynamic friction. Thus, “stiction” of the spoon bowl in one rotational position is avoided, and the spoon bowl 26 pivots freely like a pendulum below axis 18′. It follows that the spoon 10 automatically levels and substantially retains food thereon, so as to provide a person with undeveloped or impaired coordination a useful improvement in their ability to feed themselves.

While the foregoing description and drawings represent a preferred embodiment of the present invention, it will be understood that various additions, modifications and substitutions may be made therein without departing from the spirit and scope of the present invention as defined in the accompanying claims.

What is claimed is:

1. An ambidextrous spill-resistant spoon comprising:
an elongate handle portion defining a longitudinal axis;
a spoon bowl portion having a shaft part;
a rotational and clutching apparatus connecting said handle portion and said spoon bowl via said shaft part so that the spoon bowl is relatively rotationally supported below said longitudinal axis, said rotational and clutching apparatus further being responsive to a certain user input including an axial force pushing said handle portion and spoon bowl toward one another to clutch said spoon bowl non-rotationally to said handle portion to resist torque in both directions in the presence of said axial force, and said rotational and clutching apparatus being responsive to torque in the absence of said axial force to unclutch allowing said spoon bowl to freely rotate about said longitudinal axis.

2. The ambidextrous spill-resistant spoon according to claim 1, wherein said certain user input includes application by a user of an axial force along said handle pushing the spoon into food or against a bowl such that the spoon bowl reacts axially to move toward said handle portion, whereby reaction of the spoon bowl against an object such as a plate or food is sufficient to effect clutching of the spoon bowl to the handle portion.

3. The ambidextrous spill-resistant spoon according to claim 2 wherein said rotational and clutching apparatus provides for said spoon bowl to move a determined distance axially of said longitudinal axis relative to said handle portion to effect clutching of said apparatus.

4. The ambidextrous spill-resistant spoon according to claim 3 wherein said rotational and clutching apparatus includes a bushing member and a shaft member rotationally and axially movably associated with one another, each of said bushing member and said shaft member further being drivingly connected to a respective one of a pair of circular arrays of like-configured axially and circumferentially extending ratchet teeth, and said pair of circular arrays of ratchet teeth drivingly engaging one another to sustain torque in both directions in response to axial force and resulting relative movement of said shaft member and bushing member.

5. The ambidextrous spill-resistant spoon according to claim 4 wherein said pair of circular arrays of ratchet teeth each define a selected included angle, such that said ratchet teeth tend to wedge apart in response to torque in the absence of said axial force.

6. The ambidextrous spill-resistant spoon according to claim 5 further including a resilient member resisting said axial force and tending to disengage said ratchet teeth from one another.

7. The ambidextrous spill-resistant spoon according to claim 6 wherein said resilient member includes a coil spring of selected spring rate and preload disposed so as to resist engagement of said arrays of ratchet teeth with one another.

8. The ambidextrous spill-resistant spoon according to claim 4 wherein said carrier member defines one of said circular arrays of ratchet teeth, and said bushing member defines the other one of said pair of circular arrays of ratchet teeth.

9. A method of providing an ambidextrous spill-resistant and self-leveling spoon, said method comprising steps of:
providing an elongate handle portion defining a longitudinal axis;
providing a spoon bowl portion having a shaft part;
providing a rotational and clutching apparatus connecting said handle portion and said spoon bowl portion so that the spoon bowl is relatively rotationally supported below said longitudinal axis,
configuring said rotational and clutching apparatus to be responsive to an axially directed force moving said spoon bowl portion toward said handle portion to clutch said spoon bowl to said handle portion to resist torque in both directions and to be responsive to torque in the absence of said axial force to unclutch allowing said spoon bowl to freely rotate about said longitudinal axis.

10. The method of claim 9 further including steps of:
configuring said rotational and clutching apparatus to include a bushing member and a shaft member rotationally and axially movably associated with one another;
providing each of said bushing member and said shaft member to be drivingly connected to a respective one of a pair of circular arrays of ratchet teeth such that said pair of circular arrays of ratchet teeth drivingly engaging one another to sustain torque in both directions in response to axial relative movement of said shaft member and bushing member, and so that said pair of circular arrays of ratchet teeth wedge apart in response to applied torque in the absence of said axial force and movement.

11. The method of claim 10 further including the step of providing each ratchet tooth of said pair of circular arrays of ratchet teeth with a sloping tooth surfaces defining a selected included wedging angle.

12. The method of claim 10 further including the steps of: providing a spring urging said ratchet teeth out of engagement in opposition to said axial force and movement.

13. Rotational and clutching apparatus providing for connection and relative rotation of two parts as well as for selective clutching engagement of the two parts to sustain torque in response to relative axial force and movement toward one another, and for disengagement of the two parts in response to torque in the absence of axial force toward one another, said rotational and clutching apparatus comprising:
a bushing member;
a shaft member rotationally and freely axially movably received in said bushing member,
and cooperatively defining an axis;
a pair of circular arrays of plural fine-dimension axially disposed engagement teeth, each engagement tooth of said pair of circular arrays of engagement teeth being circumferentially extending, and including a radially and axially extending engagement surfaces;

14. The rotational and clutching apparatus of claim 13 further including:
said bushing member and said shaft member cooperatively defining a selected radial clearance allowing said shaft member to cant within said bushing member as well as to rotate and move axially relative to said bushing member; and
in response to a lateral force applied between said two parts said shaft member canting in said bushing member to wedge said engagement surfaces apart in cooperation with applied torque to effect disengaging of said pair of circular arrays of engagement teeth from one another.

15. The rotational and clutching apparatus of claim 14 further including: said circular arrays of plural fine-dimension engagement teeth each having engagement surfaces angulated at a selected angle relative to axial.
